(19) United States
(12) Patent Application Publication
(10) Pub. No.: US 2011/0220607 A1
(43) Pub. Date: Sep. 15, 2011

(54) PLASTIC BOTTLE CLOSURE, PLASTIC BOTTLE INCLUDING THE SAME, AND PLASTIC BOTTLE CLOSURE OPENER

(76) Inventor: Chuichiro MUKUNOKI, Osaka (JP)

(21) Appl. No.: 13/111,078

(22) Filed: May 19, 2011

Related U.S. Application Data
(63) Continuation of application No. PCT/JP2009/006268, filed on Nov. 20, 2009.

(30) Foreign Application Priority Data
Nov. 21, 2008 (JP) 2008-321592

(51) Int. Cl. B65D 51/00; B65D 41/34; B67B 7/00

(52) U.S. Cl. 215/302; 215/252; 215/305; 81/3.07

(57) ABSTRACT

A plastic bottle closure, which is screwed onto an opening of a plastic bottle, has an outer form in which an outer circumferential portion fits in a hole of a standardized dodecagonal socket wrench. The outer circumferential portion of the plastic bottle closure includes a concavo-convex portion including a plurality of convex portions and a plurality of concave portions. The concavo-convex portion fits in a convexo-concave portion of the hole of the standardized dodecagonal socket wrench.

### CROSS REFERENCE TO RELATED APPLICATION

This is a continuation application of PCT application No. PCT/JP2009/006268 filed on Nov. 20, 2009, designating the United States of America.

### BACKGROUND OF THE INVENTION

(1) Field of the Invention

The present invention relates to a plastic bottle closure made of resin, a plastic bottle including the closure, and an opener for the plastic bottle closure.

(2) Description of the Related Art

In recent years, plastic bottles are widely used for containing tea, mineral water, soft drink, and so on. A plastic bottle is composed of: a bottle body for containing drink such as tea, and a closure for sealing an opening of the bottle body.

Screw grooves are formed in each of an outer circumferential portion of the opening and an inner circumferential portion of the closure, and the opening is sealed by screwing the closure onto the opening. In addition, a fixing ring is engaged in the opening, and in a state before the plastic bottle is opened, a top edge portion of the fixing ring and a bottom edge portion of the closure are connected by a plurality of engagement bridges (connecting pieces).

For opening the plastic bottle thus configured, the closure is turned in a predetermined opening direction. This action wrings off the engagement bridges, so that the plastic bottle is opened. Then, by further turning the closure, it is possible to remove the closure from the opening.

Thus, to open the plastic bottle, it is necessary to wring off the engagement bridges. Wringing off the engagement bridge requires a predetermined closure opening torque, but for weak grip users such as children, women, and the elderly, it is not easy to open the plastic bottle. Conventionally, to facilitate opening of the plastic bottle, knurling (knurling grooves) is provided in a lateral circumferential surface of the closure to prevent slippage. However, opening the plastic bottle is still not easy for the weak grip users as described above.

Thus, conventionally, a various types of plastic bottle closures or openers for such plastic bottle closures have been suggested. The following will briefly describe the conventional techniques.

A first conventional technique has been suggested as a plastic bottle closure having a larger outer circumference (see Patent Reference 1: Japanese Unexamined Patent Application Publication No. 2006-306491).

This configuration allows increasing frictional force between fingers and the closure in opening the plastic bottle, thus allowing those having a weak grip to open the plastic bottle easily.

A second conventional technique has been suggested as a plastic bottle closure including a protrusion or extension to be caught with fingers, which is provided in an outer circumferential surface of the closure (see Patent References 2 and 3: Japanese Unexamined Patent Application Publication No. 2006-232385 and Japanese Unexamined Patent Application Publication No. 2005-298058).

This configuration allows the fingers to steadily catch the protrusion or the extension, thus allowing those having a weak grip to open the plastic bottle easily.

A third technique has been suggested as a plastic bottle closure having an outer form in a hexagonal or another polygonal shape (see Patent Reference 4: Japanese Unexamined Patent Application Publication No. 2003-341697).

This configuration provides a support for the fingers to tighten the grip, thus allowing even children and the elderly with a weak grip to open the plastic bottle easily.

A fourth conventional technique has been suggested as a bottle container with a closure opening function, which has a concavity having the same shape as the closure at the bottom of the bottle (see Patent Reference 5: Japanese Unexamined Patent Application Publication No. 2006-290456).

With this configuration, two bottle containers as above are prepared, and a concavity at the bottom of one bottle container is used as an opener by fitting the concavity into the closure of the other bottle container and turn it around. This allows opening the plastic bottle easily and safely.

A fifth conventional technique has been suggested as an opener having the same knurls in the inner circumferential surface as the knurling grooves formed in the closure (see Patent Reference 6: Japanese Unexamined Patent Application Publication No. 2001-114395).

This configuration allows inserting the opener into the closure so as to open the closure.

A sixth conventional technique has been suggested as a closure opener in which a claw or protrusion to be caught in the knurling grooves in the inner circumferential surface (see Patent References 7 and 8: Japanese Unexamined Patent Application Publication No. 2003-300597 and Japanese Unexamined Patent Application Publication No. 2001-158500).

This configuration allows the claw or protrusion in the opener to be caught in the knurling grooves in the closure, thus allowing weak grip users such as children, women, and the elderly to open the plastic bottle easily.

### SUMMARY OF THE INVENTION

However, the first conventional technique has a problem that minor increase in the outer circumferential form of the closure would not give sufficient frictional force to weak grip users. In addition, to obtain sufficient friction, it is inevitable to significantly expand the outer form of the closure, and this significantly increases an amount of resin required for forming the closure, thus causing a problem of significant increase in manufacturing costs.

In addition, in the second conventional technique, when trying to form a sufficient protrusion or the like for fingers to catch, as in the first conventional technique described above, the amount of resin required for forming the closure increases accordingly, thus causing a problem of increase in the manufacturing costs.

In addition, the third conventional technique has a problem that simply forming an outer circumferential form of the closure into a polygonal shape will not prevent slippage of hands when opening the closure, and thus it is not possible to expect a significant effect for allowing weak grip users to open the closure.

In addition, the fourth conventional technique has a problem that one plastic bottle is not sufficient for opening the plastic bottle, and at least two plastic bottles of the same type are necessary for opening the closure.

In addition, the fifth conventional technique has a problem that due to very fine structures of both the knurling grooves of the opener and the knurling grooves of the closure, it is difficult to fit these grooves together for opening the bottle. Moreover, when the fitting between the opener and the closure is tightened to effectively open the plastic bottle, the opener does not easily fit onto the closure when trying to open the bottle. On the other hand, when the fitting between the opener and the closure is loosened, there is a problem of slippage between the opener and the closure, thus not allowing the opening of the plastic bottle.

In addition, the sixth conventional technique has a problem of difficulty in appropriately fitting the claw or protrusion of the opener into the knurling grooves of the closure.

Thus, each of the closures or openers for the plastic bottle according to the first to the sixth conventional techniques has a problem and is therefore not practical.

On the other hand, in recent years, a demand for plastic bottles is growing due to increasing popularity of tea-based beverage, and in particular, small-sized plastic bottles of a 350-ml type or 500-ml type have come to function more as a canteen and widely used on a daily basis among children, women, the elderly, and so on.

For this reason, this involves opening of the plastic bottle closure not only once when opening the bottle for the first time but involves opening and closing each time a user drinks the beverage from the plastic bottle, so that opening or closing of the plastic bottle closure takes place more often than before. Thus, opening of the plastic bottle closure takes place not only once when cutting off the engagement bridges for the first time but a number of times after the bottle is once opened.

On the other hand, turning around the plastic bottle closure, as described earlier, requires a predetermined opening torque. Particularly, opening the closure for the first time after purchasing the plastic bottle requires opening torque for cutting off the engagement bridges connecting the plastic bottle closure and the fixing ring.

In addition, as described earlier, the plastic bottle is opened not only once but many times after cutting off the engagement bridges for the first time. In this case, the closure which is fastened by human force is to be opened again, but the predetermined opening torque is also required for opening the closure after cutting off the engagement bridge. This is because the user often fastens the bottle tightly to prevent leakage of the beverage from the plastic bottle after the closing. Accordingly, in some cases, the opening torque required for opening after cutting off the engagement bridge is larger than the opening torque required for cutting off the engagement bridge for the first time. This causes a problem of not allowing weak grip users such as children, women, or the elderly to open the bottle easily even after once opening the bottle.

On the other hand, besides these conventional techniques, various improvements in closure designing have conventionally been achieved such as improvements in sealing performance, opening facility, reduction in amount of resin, cost reduction and efficiency increase through streamlining of manufacturing processes, and tamper evidence (to clearly indicate a sealing status of the closure after cutting off the engagement bridges), but a sufficient and practical solution for facilitating opening the plastic bottle has not been found yet.

The present invention, conceived to solve the above problems, is to provide a practical plastic bottle closure and a plastic bottle which allow those with a weak grip to open or close the plastic bottle closure easily, and which does not involve significant increase in resin amount. In addition, the present invention is to provide an opener appropriate for the plastic bottle closure.

As a result of concentrated efforts and considerations for solutions to the problems above, the inventor of the present invention has reached the following findings.

The inventor of the present invention has attempted solving the above problems using a tool from a technical field completely different from that of the plastic bottle, by incorporating a shape and mechanical beautility of the tool. After trial and error on various types of tools, the inventor of the present invention has reached a finding that the above problems can be solved by using a standardized dodecagonal socket wrench among such various types of tools. The means to solve the problems will be described below.

To solve the above problems, a plastic bottle closure according to an aspect of the present invention is a plastic bottle closure that is screwed onto an opening of a plastic bottle body (hereinafter, simply referred to as the “closure”), and an outer circumferential form of the closure includes a concavo-convex portion in which each of twelve concave portions and each of twelve convex portions are alternately arranged, and the concavo-convex portion of the closure fits in a convexo-concave portion of an inner circumferential form of a hole of a dodecagonal socket wrench that is standardized.

Thus, the standardized socket wrench is used for the closure according to the aspect of the present invention, and particularly the closure has an outer circumferential form that is defined using a dodecagonal socket wrench instead of a hexagonal socket wrench or the like.

Thus, the closure according to an aspect of the present invention is conceived based on a very original and innovative idea of defining the outer circumferential form of the closure using the standardized dodecagonal socket wrench. Then, this configuration allows those with a weak grip to easily open or close the plastic bottle closure with bare hands, and also allows realizing a practical closure which does not involve significant increase in resin amount. Particularly, with the closure according to an aspect of the present invention, it is possible to open the closure easily when cutting off the engagement bridges to open the closure.

Furthermore, in the closure according to an aspect of the present invention, it is preferable that: when a circle connecting an apex of each of the twelve convex portions in the closure is a closure addendum circle, and a circle connecting a bottom of each of the twelve concave portions is a closure dedendum circle, and when a circle connecting an apex of each of twelve concave portions of the dodecagonal socket wrench is a wrench hole addendum circle, and a circle connecting a bottom of each of twelve concave portions of the dodecagonal socket wrench is a wrench hole dedendum circle, the closure be represented by: diameter of the closure dedendum circle diameter of the wrench hole addendum circle<diameter of the closure addendum circle diameter of the wrench hole dedendum circle.

Furthermore, in the closure according to an aspect of the present invention, it is preferable that the closure be approximately circular-arc shaped at a bottom of each of the twelve concave portions in the concavo-convex portion.

Furthermore, in the closure according to an aspect of the present invention, the concavo-convex portion may be formed only in a portion in a height direction of the closure.

This allows fingers to reach and catch a back side of the concavo-convex portion, thus further facilitating the opening or closing of the closure. Furthermore, since the concavo-convex portion is not formed to be level with an overall height of the closure, it is possible to significantly reduce a material required for forming the concavo-convex portion.

Furthermore, in the closure according to an aspect of the present invention, the concavo-convex portion may be formed only in an upper part of a lateral portion of the closure and may also be formed in an entire circumference of the lateral portion of the closure.

Furthermore, in the closure according to an aspect of the present invention, the concavo-convex portion may be formed only in a lower part of a lateral portion of the closure and may also be formed in an entire circumference of the lateral portion of the closure.

Furthermore, in the closure according to an aspect of the present invention, a flat portion is formed in each of the twelve convex portions in the concavo-convex portion, the flat portion having an angular shape at each of end portions.

This allows reducing the material required for forming the concavo-convex portion. In addition, since it is possible to form, by providing the flat portion, an angular portion in the convex portion, thus allowing forming a portion that can be sufficiently caught with finger pads. This accordingly allows easy opening of the closure.

Furthermore, in the closure according to an aspect of the present invention, it is preferable that a through hole having a diameter of 1.2 mm to 1.8 mm be formed in each of the twelve convex portions in the concavo-convex portion.

This allows reducing the amount of material required for forming the concavo-convex portion. Furthermore, it is possible to further reduce manufacturing time in manufacturing processing for forming the material into the concavo-convex portion.

Furthermore, in the closure according to an aspect of the present invention, the dodecagonal socket wrench is specified by Japanese Industrial Standards (JIS), according to a JIS standard number B4636-1.

This allows anyone, in Japan, to easily manufacture a closure having a constant form according to the present invention.

Furthermore, in the closure according to an aspect of the present invention, it is preferable that the dodecagonal socket wrench have a nominal size of 30 mm.

This allows obtaining a closure having an appropriate size to allow opening of the closure.

In addition, in a plastic bottle according to an aspect of the present invention includes: the closure according to the above-described aspect of the present invention; and a plastic bottle body including an opening onto which the closure is screwed.

This allows realizing a plastic bottle including the closure which allows those with a weak grip to open or close the bottle easily with bare hands.

In addition, an opener for opening a plastic bottle closure (hereinafter, simply referred to as the “opener”) according to an aspect of the present invention is an opener for opening the closure according to the above-described aspect of the present invention, and the opener includes a through hole having a same shape as a hole of a standardized dodecagonal socket wrench.

This allows further facilitating opening or closing of the closure according to the aspect of the present invention. Particularly, when opening the closure by cutting off the engagement bridges, it is possible to open the closure very easily.

According to the present invention, even a person having a weak grip can easily open or close a closure of a plastic bottle with bare hands. Particularly, when opening the closure by cutting off the engagement bridges, it is possible to open the closure very easily, and this produces a significant advantageous effect. Furthermore, the closure thus formed using a shape of a hole of a standardized dodecagonal socket wrench does not involve significant increase in resin amount in the manufacturing, thus allowing manufacturing the closure without requiring excessive manufacturing costs.

In addition, an opener according to the present invention is appropriate for the closure according to the present invention as described above, and makes it easier to open or close the plastic bottle closure.

### FURTHER INFORMATION ABOUT TECHNICAL BACKGROUND TO THIS APPLICATION

The disclosure of Japanese Patent Application No. 2008-321592 filed on Nov. 21, 2008, including specification, drawings and claims is incorporated herein by reference in its entirety.

The disclosure of PCT application No. PCT/JP2009/006268 filed on Nov. 20, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A is a plan view of a closure according to a first embodiment of the present invention;

FIG. 1B is a partially cutaway cross-sectional side view of the closure shown in FIG. 1A;

FIG. 1C is an external perspective view of the closure shown in FIGS. 1A and 1B;

FIG. 2 is a diagram showing a state in which the closure according to the first embodiment of the present invention fits in a socket hole of a dodecagonal socket wrench;

FIG. 3 is a plan view of a closure according to a variation of the first embodiment of the present invention;

FIG. 4 is a partially cutaway cross-sectional side view of a plastic bottle according to the first embodiment of the present invention;

FIG. 5A is an external perspective view of the plastic bottle according to the first embodiment of the present invention in a state in which the closure is opened;

FIG. 5B is an external perspective view of the plastic bottle according to the first embodiment of the present invention in a state in which the closure is closed;

FIG. 6 is a partially cutaway cross-sectional side view of the closure according to a variation of the first embodiment of the present invention;

FIG. 7A is a plan view of a closure according to a second embodiment of the present invention;

FIG. 7B is a partially cutaway cross-sectional side view of the closure shown in FIG. 7A;

FIG. 7C is an external perspective view of the closure shown in FIG. 7A and FIG. 7B;

FIG. 8A is a plan view of a closure according to a third embodiment of the present invention;

FIG. 8B is a partially cutaway cross-sectional side view of the closure shown in FIG. 8A;

FIG. 8C is an external perspective view of the closure shown in FIG. 8A and FIG. 8B;

FIG. 9A is a plan view of a closure according to a fourth embodiment of the present invention;

FIG. 9B is a partially cutaway cross-sectional side view of the closure shown in FIG. 9A;

FIG. 9C is a diagram showing a state in which the plastic bottle is closed by screwing the closure shown in FIGS. 9A and 9B onto a plastic bottle body;

FIG. 10A is a plan view of a closure according to a fifth embodiment of the present invention;

FIG. 10B is a partially cutaway cross-sectional side view of the closure shown in FIG. 10A;

FIG. 10C is an external perspective view of the closure shown in FIG. 10A and FIG. 10B;

FIG. 11A is a plan view of an opener according to a sixth embodiment of the present invention;

FIG. 11B is a cross-sectional view of the opener shown in FIG. 11A;

FIG. 12 is a diagram showing a state in which the opener according to the sixth embodiment of the present invention is attached to the closure according to the first embodiment; and

FIG. 13 is an external perspective view of a closure according to a seventh embodiment of the present invention.

### DESCRIPTION OF THE PREFERRED EMBODIMENTS

Hereinafter, a closure according to embodiments of the present invention and a plastic bottle including the closure, and an opener according to the embodiments of the present invention will be described in detail with reference to the drawings.

### First Embodiment

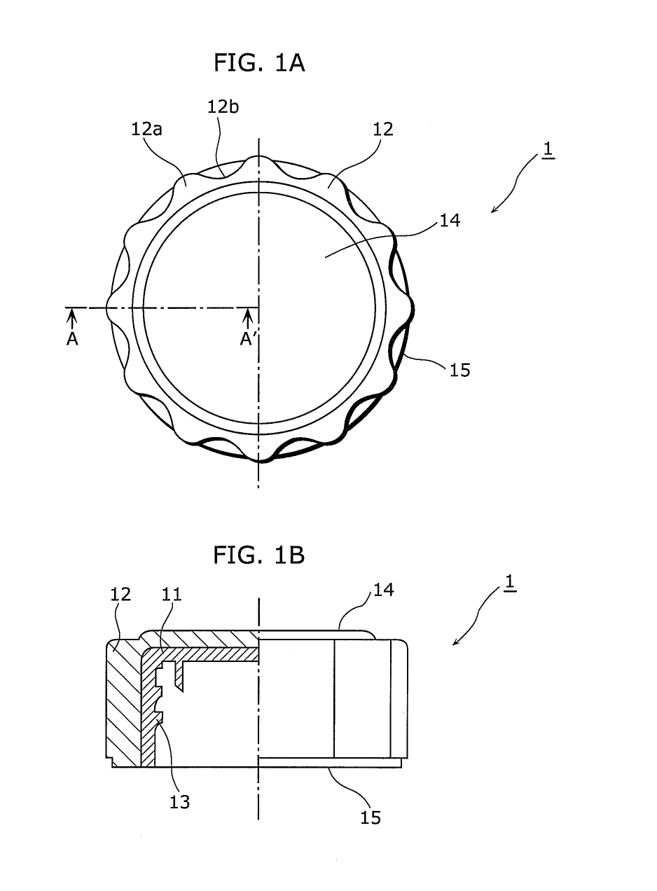

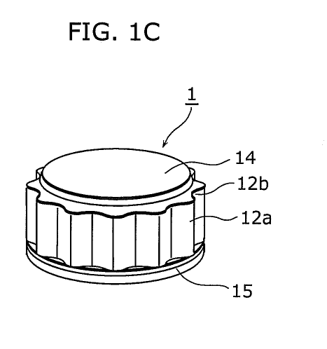

First, a closure 1 according to a first embodiment of the present invention will be described in detail with reference to the drawings. FIG. 1A is a plan view of the closure 1 according to the first embodiment of the present invention, and FIG. 1B is a partially cutaway cross-sectional side view of the closure shown in FIG. 1A. A cross-sectional portion in FIG. 1B shows a cross section of the closure when cut away along line A-A′ shown in FIG. 1A. In addition, FIG. 1C is an external perspective view of the closure shown in FIGS. 1A and 1B.

As shown in FIGS. 1A to 1C, the closure 1 according to the first embodiment of the present invention includes a closure base portion 11 and a concavo-convex portion 12.

The closure base portion 11 has a capped cylindrical shape, and, for example, is the same as an existing closure included in a plastic bottle available on the market. Accordingly, in an inner circumferential portion of the closure base portion 11, a screw portion 13 is formed which has the same form as the screw portion formed in the existing closure.

The concavo-convex portion 12 is provided by forming resin into an annular shape in an outer circumferential portion. The concavo-convex portion 12 is formed to correspond to an inner circumferential shape of a hole of a standardized dodecagonal socket wrench (hereinafter, simply referred to as a “dodecagonal socket wrench”), and is formed to fit in a convexo-concave portion of the hole of the dodecagonal socket wrench. Accordingly, as shown in FIG. 1A, an outer circumference of the concavo-convex portion 12 has a wave-like form in a planer view, and includes, in an external side which is formed to project outward from an inside of the closure base portion 11, 12 convex portions 12a and 12 concave portions 12b each of which is formed between each of the convex portions 12a. The convex portions 12a and the concave portions 12b are alternately and periodically placed in the outer circumferential portion of the closure base portion 11. Note that hereinafter the “hole of the standardized dodecagonal socket wrench” is simply referred to as a “dodecagonal socket wrench hole”.

On a top surface of the closure base portion 11, a closure top portion 14 made of a same resin material as the concavo-convex portion 12 is formed. The closure top portion 14 is sequentially formed along with the concavo-convex portion 12. This allows increasing adherence of resin to the closure base portion 11 of the concavo-convex portion 12.

In addition, in a lower part of a cylindrical portion of the closure base portion 11, an opener supporting portion 15 is formed for supporting the opener described below. The opener supporting portion 15 supports the opener when opening or closing the closure, and is formed into an annular shape outwardly projecting from a lower end portion of the closure 1. In the present embodiment, it is assumed that the opener supporting portion 15 has a thickness (vertical height) of approximately 1 mm, and the outwardly projecting portion also has a thickness of approximately 1 mm.

In the closure according to the first embodiment of the present invention, Japanese Industrial Standards (JIS) is used as the standard of the dodecagonal socket wrench above. Specifically, the dodecagonal socket wrench according to a JIS standard number “JISB4636-1” is used. Note that the standard number is entitled “socket wrench—12.7 square drive”. In the closure 1, the concavo-convex portion 12 that is an outer circumferential shape of the closure 1 is formed using a dodecagonal socket wrench among the socket wrenches according to this JISB4636-1.

Meanwhile, in Japan, a size of a major part of the closures of plastic bottles available on the market is 28 mm in diameter in the context of manufacturing machines used by manufactures, and the size is a de facto standard. Accordingly, the existing closure having a diameter of 28 mm is used as the closure base portion 11 in the closure 1. In addition, since an outer diameter of the closure having a diameter of 28 mm is approximately 30 mm, the hole of the dodecagonal socket wrench according to JIS84636-1 has a nominal size of 30 mm. Accordingly, in the case of using the existing plastic bottle available on the market, as with the closure 1 according to the present embodiment, it is sufficient to use the standard of the socket of the dodecagonal socket wrench having a nominal size of 30 mm according to JISB4636-1. Note that in the case of using the closure having an outer diameter of 32 mm, it is sufficient to use the standard of the socket of the dodecagonal socket wrench having a nominal size of 32 mm according to JISB4636-1.

When forming the concavo-convex portion 12 of the closure 1 using the hole of the dodecagonal socket wrench having a nominal size of 30 mm according to JISB4636-1, for the concavo-convex portion 12, a diameter (maximum outer diameter) of a circle connecting an apex of each convex portion 12a (addendum circle) is approximately 35 mm, and a diameter (minimum outer diameter) of a circle connecting a bottom of each concave portion 12b (dedendum circle) is approximately 31.4 mm, and a height (depth) of each convex portion 12a that is a radial distance between the addendum circle and the dedendum circle is approximately 1.8 mm because the height is half a difference between a maximum outside diameter and a minimum outside diameter. In addition, a pitch between each convex portion 12a is approximately 9.16 mm. Such shape and dimensions of the concavo-convex portion 12 are represented by ideal values for preventing slippage of the closure when opening the closure and allowing the closure to appropriately bite into finger pads.

Thus, the outer circumferential portion of the closure 1 according to the first embodiment of the present invention is formed to fit in the standardized dodecagonal socket wrench hole. In other words, the concavo-convex portion of the closure 12 has a configuration to fit in the convexo-concave portion of the standardized dodecagonal socket wrench hole. Here, it is possible to consider a variety of specific forms in which the concavo-convex portion 12 of the closure 1 and the convexo-concave portion of the standardized dodecagonal socket wrench hole fit together. The following will described this point in detail. Note that the case of using a socket of the dodecagonal socket wrench specified by JISB4636-1 will be described.

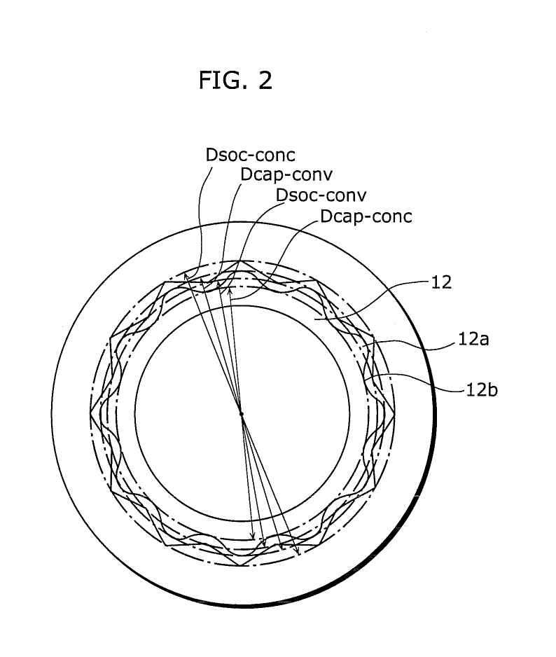

As shown in FIG. 2, an inner circumferential form of the hole of the dodecagonal socket wrench according to JISB4636-1 includes a shape of two regular hexagons overlapped and displaced from each other by 30 degrees. In other words, the inner circumferential form of the socket hole has a convexo-concave portion having an apex angle of 120 degrees at each convex portion and a base angle of 120 degrees at the bottom.

The form of the concavo-convex portion 12 of the closure 1 that fits in the hole of the dodecagonal socket wrench according to JISB4636-1 is a form having a relationship represented by D_{Cap-Conc}≦D_{Soc-Conv}<D_{Cap-Conv}≦D_{Soc-Conc} when D_{Cap-Conv} is a diameter of a circle (circumscribed circle) connecting an apex of each convex portion 12a of the closure 1 in the concavo-convex portion 12, D_{Cap-Conc} is a diameter of a circle connecting a bottom of each concave portion 12b of the concavo-convex portion 12, D_{Soc-Conv} is a diameter of a circle (inscribed circle) connecting an apex of each convex portion of the convexo-concave portion of the hole in the dodecagonal socket wrench according to JISB4636-1, and D_{Soc-Conc} is a diameter of a circle connecting a bottom of each concave portion of the convexo-concave portion of the socket hole. According to this, the concavo-convex portion 12 of the closure 1 fits in the convexo-concave portion of the dodecagonal socket wrench hole.

In this case, the entire concavo-convex portion 12 of the closure 1 can be formed, as shown in FIG. 2, for example, into a smooth wave-like shape having both the apex of the convex portion 12a and the bottom of the concave portion 12b in an approximately circular-arc shape.

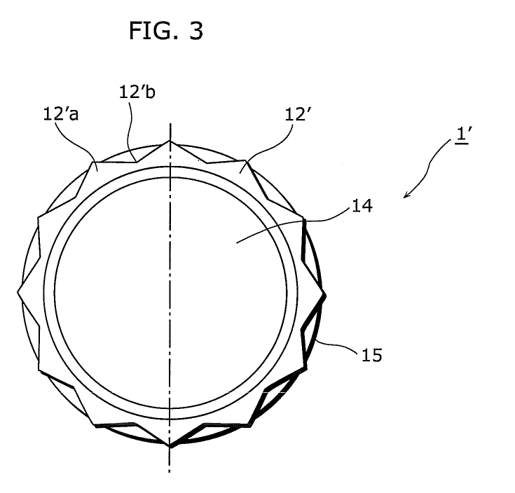

Note that the concavo-convex portion of the closure can be formed into a shape as shown in FIG. 3. FIG. 3 is a plan view of the closure 1′ according to a variation of the first embodiment of the present invention. As shown in FIG. 3, the concavo-convex portion 12′ of the closure 1′ according to the variation of the first embodiment of the present invention is formed into a serrated wave-like from in which each of convex portions 12′a has an apex angle of 120 degrees and each of concave portions 12′b has a base angle of 120 degrees at the bottom, so as to have a shape similar to the shape of the convexo-concave portion of the socket hole described above. However, it is preferable that the concave portions 12′b of the concavo-convex portion 12′ have a sufficient radius R to prevent cracking. In other words, at least the concave portions 12′b should preferably be formed into an approximately circular-arc shape.

In addition, for the shape of the concavo-convex portion 12 of the closure 1 shown in FIG. 1A, it is preferable that all the 12 convex portions 12a have the same shape, and that all the 12 concave portions 12b have the same shape. This also applies to the concavo-convex portion 12′ of the closure 1′ shown in FIG. 3.

Furthermore, it is preferable that a predetermined clearance (space) be provided between the concavo-convex portions 12 of the closure 1 and the convexo-concave portion of the standardized socket wrench hole. This applies to the case of deleting an equation condition from the relational expressions of the four diameters above. The clearance should preferably be from 0.2 mm to 1.0 mm. In addition, the clearance should preferably be equally provided at every point between the concavo-convex portion 12 of the closure 1 and the convexo-concave portion of the socket hole. Such clearance should be provided likewise in the closures 2, 3, and 5 according the second, third, and fifth embodiments described below.

As described above, the closure 1 according to the first embodiment of the present invention is manufactured using the hole of a standardized dodecagonal socket wrench, and it is possible to form an outer circumferential shape of the closure 1 by transcribing the shape of the socket hole.

Next, a plastic bottle 100 according to the first embodiment of the present invention will be described with reference to the drawings.

FIG. 4 is a partially cutaway cross-sectional side view of the plastic bottle 100 according to the first embodiment of the present invention.

As shown in FIG. 4, the plastic bottle 100 according to the first embodiment of the present invention includes the closure 1 as shown in FIGS. 1A to 1C and described earlier, and a plastic bottle body 80.

In the closure 1, as described earlier, includes: a concavo-convex portion 12 having a wave-like form is formed in the outer circumferential portion of the closure base portion 11, and a screw portion 13 is in the inner circumferential portion of the closure base potion 11. Note that although not shown, the inner circumferential portion of the closure 1 includes, in some cases, a vent slot which is a vertically-cut slot for gradually releasing gas inside the plastic bottle body 80 when opening the plastic bottle 100.

The plastic bottle body 80 includes, in an upper part thereof, an opening 81 used as a drinking spout, and a screw portion 82 is formed in an external portion of the opening 81. The screw portion of the plastic bottle 100 is made up of the screw portion 82 of the opening 81 and the screw portion 13 of the closure 1.

In addition, in a lower part of the opening 81 in the plastic bottle body 80, a fitting groove 83 is formed. The fitting groove 83 includes a fixing ring 90 which is annularly shaped. As shown in FIG. 4, when the bottle is sealed before opened for the first time, the closure 1 is fixedly connected to the fixing ring 90 by a plurality of engagement bridges (connecting pieces) 91. Note that the plastic bottle body 80 is charged with a predetermined beverage such as tea, mineral water, soft drink, and sparking drink such as carbonated drink or sparkling liquor.

When opening the plastic bottle 100 thus configured, the engagement bridges 91 connecting the closure 1 and the fixing ring 90 are wrung off by turning the closure 1 into a predetermined opening direction. By further turning around the closure 1, it is possible to remove the closure 1 from the opening 81 and open the plastic bottle 100.

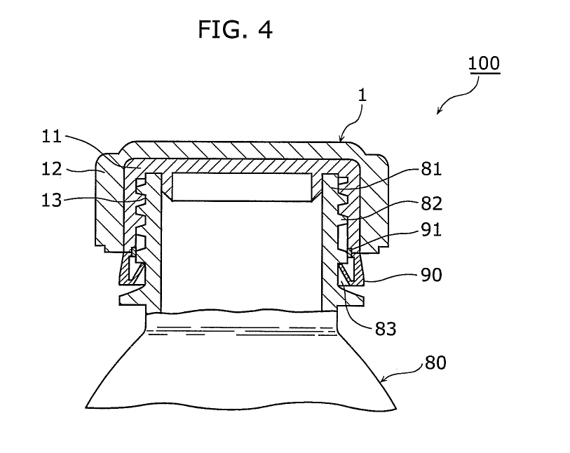

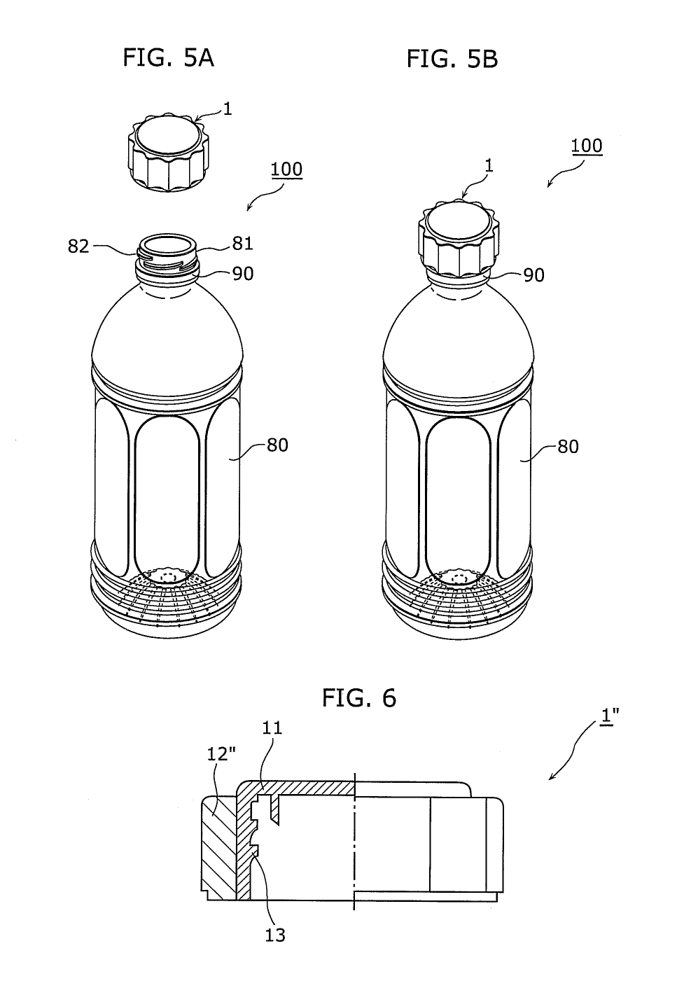

FIGS. 5A and 5B are external perspective views of the plastic bottle 100 according to the first embodiment of the present invention, with FIG. 5A showing an external view of the plastic bottle 100 according to the first embodiment of the present invention in a state in which the plastic bottle 100 is opened, and FIG. 5B showing an external perspective view of the plastic bottle 100 according to the first embodiment of the present invention in a state in which the plastic bottle 100 is closed.

By applying a predetermined torque to the closure 1 and turning the closure in a predetermined opening direction, it is possible to remove, as shown in FIG. 5A, the closure 1 from the opening 81 and open the plastic bottle 100.

In addition, the closure 1 is detachably and attachably screwed onto the opening 81, and after the engagement bridges are cut off, it is possible to close the plastic bottle 100, as shown in FIG. 5B, by screwing the closure 1 onto the opening 81. Furthermore, by threading the screw portion of the closure 1 into the screw portion 82 of the opening 81 and turning back the closure 1, it is possible to open the plastic bottle 100 again.

As described above, the closure 1 according to the first embodiment of the present invention and the plastic bottle 100 including the closure 1 include a concavo-convex portion 12 which is formed to fit in a standardized dodecagonal socket wrench hole, so that the concavo-convex portion 12 appropriately bites into the finger pads and prevents slippage, thus allowing those having a weak grip to open the plastic bottle 100 quickly and easily with bare hands. In addition, since the closure 1 according to the first embodiment of the present invention includes the concavo-convex portion 12, it is possible to easily tighten the closure 1 onto the opening 81 of the plastic bottle body 80 not only when opening but also when closing the plastic bottle 100. Furthermore, since the concavo-convex portion 12 of the closure 1 according to the first embodiment of the present invention has a wave-like serrated form including larger concavity and convexity, and this allows the finger pads of a person trying to open or close the plastic bottle 100 to touch the concavo-convex portion 12 exactly in a rack-and-pinion state, and this not only facilitates opening or closing of the closure but also allows quick turning of the closure.

In addition, since a portion processed with knurling grooves in the conventional closure is extremely thin, cracking is likely to occur when trying to increase a pitch or a height of the grooves to prevent slippage. In contrast, since the closure 1 according to the first embodiment of the present invention has the concavo-convex portion 12 including 12 convex portions 12a and 12 concave portions 12b, it is possible to increase a curvature radius of a wave-like R-form of the concavo-convex portion 21, that is, a curved form of each convex portion and each concave portion that is located between each of the convex portions. Accordingly, no cracking is likely to occur in the closure according to the first embodiment of the present invention.

In addition, for the closure 1 according to the first embodiment of the present invention, forming the concavo-convex portion 12 results in increase in amount of resin used for the entire closure compared to the amount of resin used for the existing closure, but the increase in the amount of resin is limitative and minute because the concavo-convex portion 12 is formed according to a dodecagonal socket wrench hole. More specifically, the closure 1 according to the first embodiment of the present invention is not simply based on a technical idea of increasing an outer diameter of the closure, but realizes an innovative technique utilizing a specific tool from a specific technical field completely different from the technical field of the plastic bottle. As described earlier, the closure 1 increases openability of the closure to the maximum extent possible by suppressing increase in the diameter of the outer form of the closure to the minimum extent possible, by using a dodecagonal socket wrench as described earlier.

Furthermore, since an already standardized tool is used for forming the concavo-convex portion that is the outer form of the closure 1, it is possible to standardize the shape and size of the closure.

In addition, an existing closure is used, as the closure base portion 11, for the closure 1 according to the first embodiment of the present invention. Accordingly, this requires no change of size or shape of the screw portion 13 of the closure base portion 11, and due to its compatibility, it is possible to divert a used closure to a conventional plastic bottle manufactured by another company.

Note that the same standard used for the standardized socket wrench includes not only a dodecagonal socket wrench but also a hexagonal socket wrench. Accordingly, it is also possible to consider forming an outer circumferential form of the closure using a hole of the hexagonal socket wrench, instead of using the hole of the dodecagonal socket wrench as in the closure 1 according to the first embodiment. However, a hexagonal socket wrench hole is smaller than a dodecagonal socket wrench hole in diameter of an inscribed circle of the convexo-concave portion. Thus, when using the hexagonal socket wrench, a hexagonal socket wrench which is one size larger than the dodecagonal socket wrench should be applied. This results in significant increase in the amount of resin required for forming the concavo-convex portion 12, and therefore is not preferable. In addition, an inner circumference of the socket hole of the hexagonal socket wrench has a regular hexagon shape. For this reason, when using the hexagonal socket wrench hole for forming the outer circumference of the closure, the outer circumferential form of the closure becomes hexagonal, so that the concavo-convex portion 12 as shown in FIG. 1A is not formed. Thus, in the case of the outer circumferential form of the closure having a polygonal shape such as a hexagon, when turning around the closure, the outer circumferential surface does not appropriately bite into the finger pads, thus causing slippery. This is particularly because the concave portion 12b is not formed. Accordingly, as the standardized socket wrench used for forming the closure 1, not a hexagonal but a dodecagonal socket wrench is used.

As described above, in the closure 1 according to the first embodiment of the present invention, the closure top portion 14 is formed on the closure base portion 11 as shown in FIG. 1B, but the closure top portion 14 need not be formed as show in FIG. 6. FIG. 6 is a partially cutaway cross-sectional side view of the closure 1″ according to a variation of the first embodiment of the present invention.

As shown in FIG. 6, in the closure 1″ according to a variation of the first embodiment of the present invention, the closure top portion 14 as shown in FIG. 1B is not formed on the closure base portion 11. In other words, in the closure 1″ according to a variation of the first embodiment of the present invention, the concavo-convex portion 12″ is formed only in a lateral circumferential portion of the closure base portion 11. This allows, compared to the closure 1 shown in FIG. 1B, decreasing the amount of resin to be formed into the closure base portion 11, and thus allowing forming the closure 1″ with the least possible amount of resin.

### Second Embodiment

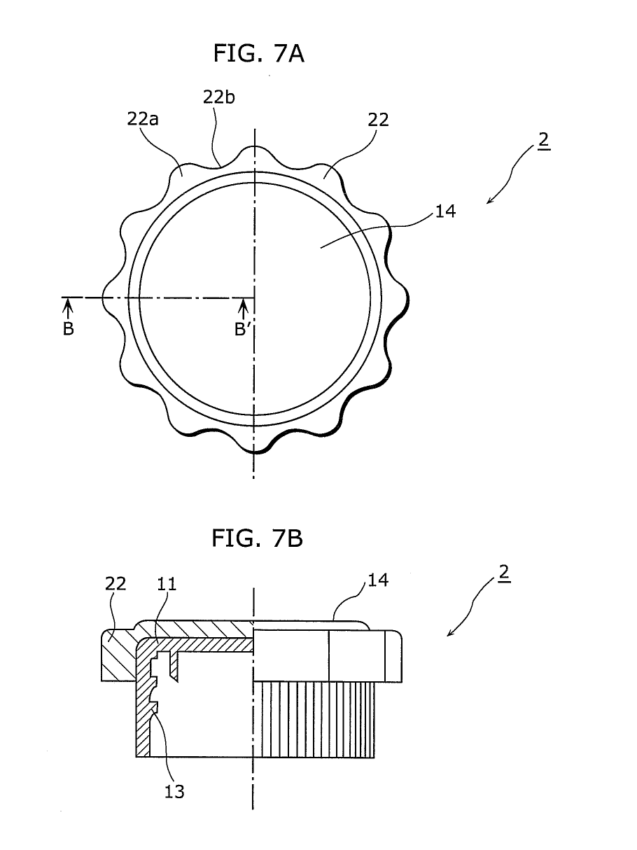

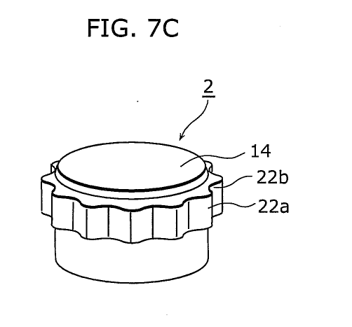

Next, the following will describe a closure 2 according to a second embodiment of the present invention. FIG. 7A is a plan view of the closure 2 according to the second embodiment of the present invention, and FIG. 7B is a partially cutaway cross-sectional side view of the closure 2 shown in FIG. 7A. A cross-sectional portion in FIG. 7B shows a cross section of the closure when cut away along line B-B′ shown in FIG. 7A. FIG. 7C is an external perspective view of the closure shown in FIGS. 7A and 7B.

The closure 2 according to a second embodiment of the present invention is characterized in that the concavo-convex portion 22 formed using a dodecagonal socket wrench hole is formed only in a portion in a height direction of the closure.

The closure 2 according to the second embodiment of the present invention as shown in FIGS. 7A to 7C includes a concavo-convex portion only in an upper part of the lateral circumferential portion of the closure 2.

Note that the same configurations in FIGS. 7A to 7C as those of the closure 1 according to the first embodiment of the present invention are assigned with the same numerical references, and the descriptions thereof will be omitted.

As shown in FIGS. 7A to 7C, the closure 2 according to the second embodiment of the present invention includes the concavo-convex portion 22 in a lateral circumferential portion in an upper third of a total height of the closure base portion 11.

The outer form of the concavo-convex portion 22 is formed so as to fit in the standardized dodecagonal socket wrench hole, as with the concavo-convex portion 12 of the closure 1 according to the first embodiment of the present invention. Accordingly, the concavo-convex portion 22, as shown in FIG. 7A, has a wave-like outer circumference form, and includes 12 convex portions 22a, and 12 concave portions 22b each of which is formed between each of the 12 convex portions 22a. Note that the form of fitting is the same as the closure 1 according to the first embodiment of the present invention, and thus the detailed description thereof will be omitted.

In the closure 2 according to the second embodiment of the present invention, the closure of 14 mm in height and 30 mm in outer diameter is used as the existing closure that is to be the closure base portion 11, as with the closure 1 according to the first embodiment of the present invention. Accordingly, as the socket of the dodecagonal socket wrench, a socket of a dodecagonal socket wrench having a nominal size of 30 mm according to JISB4636-1 is applied.

As described above, in the closure 2 according to the second embodiment of the present invention, since the concavo-convex portion 22 is formed only in a portion in the height direction of the closure, and since this allows the fingers to reach and catch a back side of the closure 2 when grabbing the concavo-convex portion, it is possible to open or close the closure more easily compared to the closure 1 according to the first embodiment of the present invention.

Furthermore, in the closure 2 according to the second embodiment of the present invention, since the concavo-convex portion 22 is formed only in a part of the circumferential portion of the closure base portion 11, it is possible to significantly reduce the amount of resin required for forming the concavo-convex portion as compared to the closure 1 according to the first embodiment of the present invention.

### Third Embodiment

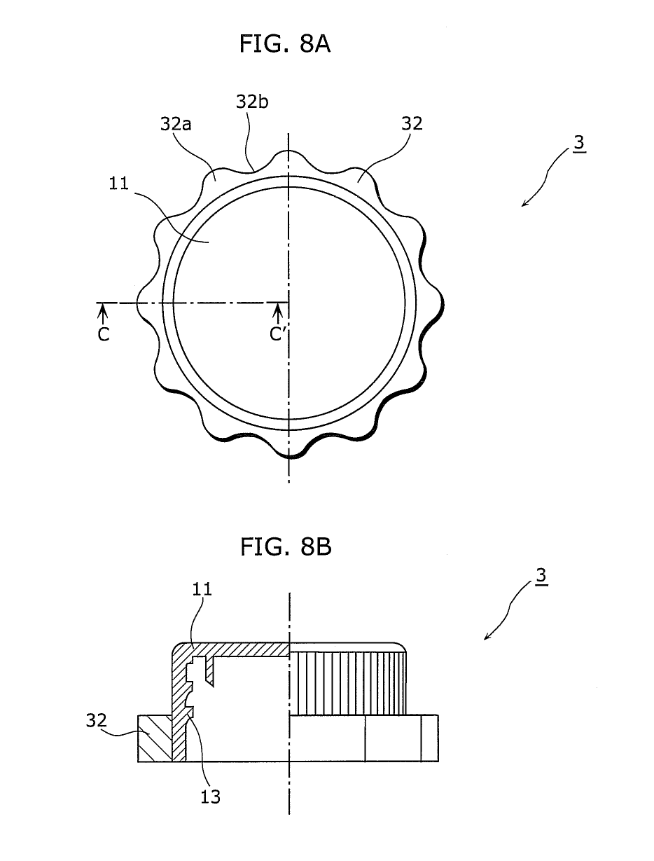

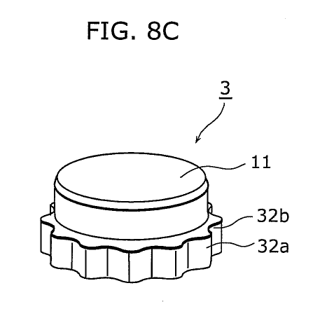

Next, the following will describe a closure 3 according to a third embodiment of the present invention. FIG. 8A is a plan view of the closure 3 according to the third embodiment of the present invention, and FIG. 8B is a partially cutaway cross-sectional side view of the closure 3 shown in FIG. 8A. A cross-sectional portion in FIG. 8B shows a cross section of the closure when cut away along line C-C′ shown in FIG. 8A. FIG. 8C is an external perspective view of the closure shown in FIGS. 8A and 8B.

The closure 3 according to the third embodiment as shown in FIGS. 8A to 8C includes a concavo-convex portion only in a lower part of the lateral circumferential portion of the closure 3.

Note that the same configurations in FIGS. 8A to 8C as those of the closure 1 according to the first embodiment of the present invention are assigned with the same numerical references, and the descriptions thereof will be omitted.

As shown in FIGS. 8A to 8C, the closure 3 according to the third embodiment of the present invention includes the concavo-convex portion 32 in a lateral circumferential portion in a lower third of a total height of the closure base portion 11.

For the closure 3 according to the third embodiment of the present invention, the closure of 14 mm in height and 30 mm in outer diameter is used as the existing closure that is to be the closure base portion 11, as with the closure 1 according to the first embodiment of the present invention. Accordingly, as the socket of the dodecagonal socket wrench, a socket of a dodecagonal socket wrench having a nominal size of 30 mm according to JISB4636-1 is applied.

As described above, the closure 3 according to the third embodiment of the present invention can produce the same advantageous effect as the advantageous effect produced by the closure 1 according to the first embodiment of the present invention.

Furthermore, in the closure 3 according to the third embodiment of the present invention, since the concavo-convex portion 32 is formed only in a part of the lateral circumferential portion of the closure base portion 11, it is possible to significantly reduce the amount of resin required for forming the concavo-convex portion as compared to the closure 1 according to the first embodiment of the present invention.

### Fourth Embodiment

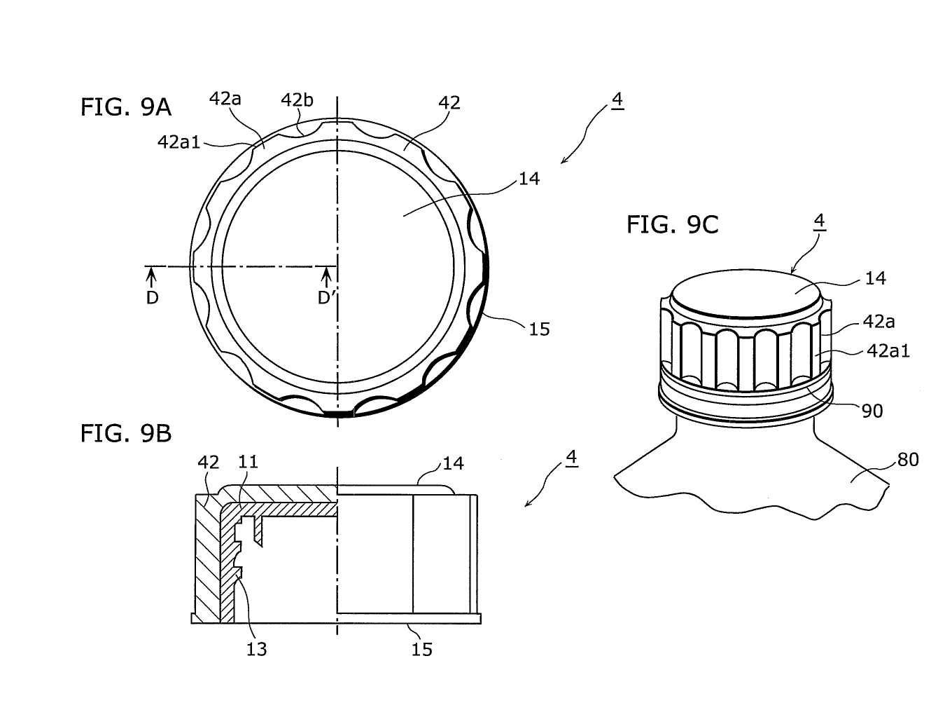

Next, the following will describe a closure 4 according to a fourth embodiment of the present invention. FIG. 9A is a plan view of the closure 4 according to the fourth embodiment of the present invention, and FIG. 9B is a partially cutaway cross-sectional side view of the closure 4 shown in FIG. 9A. A cross-sectional portion in FIG. 9B shows a cross section of the closure when cut away along line D-D′ shown in FIG. 9A. In addition, FIG. 9C shows a state in which the plastic bottle is closed by screwing the closure 4 according to the fourth embodiment of the present invention onto the plastic bottle body 80.

A feature of the closure 4 according to the fourth embodiment of the present invention is that convex portions 42a of the concavo-convex portion 42 formed using the dodecagonal socket wrench hole are flat-topped.

More specifically, in the closure 1 according to the first embodiment of the present invention as shown in FIG. 1A, an outer circumference of the convex portions 12a of the concavo-convex portion 12 of the closure 1 is formed in a curved form; whereas, in the closure 4 according to the fourth embodiment of the present invention as shown in FIGS. 9A and 9B, each of the convex portions 42a of the concavo-convex portion 42 of the closure 4 includes a flat portion 42a1 in a state in which the top of the convex portion 42a is eliminated and the outer circumference of the top of the convex portion 42a has a linear shape.

Note that the same configurations in FIGS. 9A to 9C as those of the closure 1 according to the first embodiment of the present invention are assigned with the same numerical references, and the descriptions thereof will be omitted.

As shown in FIGS. 9A to 9C, the closure 4 according to the fourth embodiment of the present invention includes the flat portion 42a1 formed around the lateral circumferential portion of the closure base portion 11 and having the concavo-convex portion 42 which is flat-topped. In other words, the outer form of the concavo-convex portion 42 is formed into a spur-gear shape, with each convex portion 42a of the concavo-convex portion 42 constituting a tip of the spur-gear.

The concavo-convex portion 42 is formed so as to fit in a dodecagonal socket wrench hole, as with the concavo-convex portion 12 of the closure 1 according to the first embodiment of the present invention. However, since the convex portion 42a of the concavo-convex portion 42 has the flat portion 42a1, unlike the closures according to the first to third embodiments of the present invention, there is no case where the concavo-convex portion completely matches the dodecagonal socket wrench. In other words, there is always a gap at least between each of the convex portions 42a of the concavo-convex portion and a corresponding one of the concave portions in the convexo-concave portion of the socket hole, and a diameter of a circle connecting the flat portion 42a1 of each convex portion 42a is slightly smaller than a diameter of a circle connecting the bottom of each concave portion of the socket hole. On the other hand, the concave portion 42b of the concavo-convex portion 42 is formed to correspond to the convex portion of the dodecagonal socket wrench hole.

Thus, in the closure 4 according to the fourth embodiment of the present invention, the concavo-convex portion 42 is also formed to fit in the dodecagonal socket wrench hole. Note that for the form of fitting, the same form as in the closure 1 according to the first embodiment of the present invention is applicable, and the detailed description thereof will therefore be omitted.

In the closure 4 according to the fourth embodiment of the present invention, the closure of 14 mm in height and 30 mm in outer diameter is used as the existing closure that is to be the closure base portion 11, as with the closure 1 according to the first embodiment of the present invention. Accordingly, as the socket of the dodecagonal socket wrench, a socket of a dodecagonal socket wrench having a nominal size of 30 mm according to JISB4636-1 is applied.

As described above, the closure 4 according to the fourth embodiment of the present invention can produce the same advantageous effect as the advantageous effect produced by the closure 1 according to the first embodiment of the present invention.

Furthermore, in the closure 4 according to the fourth embodiment of the present invention, since the flat portion 42a1 is included in each of the convex portions 42a of the concavo-convex portion 42, it is possible to reduce the amount of resin required for forming the convex portion as compared to the closure 1 according to the first embodiment of the present invention.

Furthermore, by forming the flat portion 42a1, it is possible to form an angular portion in each of the convex portions 42a at an end portion of the flat portion 42a1. This allows forming a portion to be sufficiently caught with the finger pads and producing an anti-slip effect, and thus allows making it easier to open of the closure.

Note that it is also possible to apply, to the closure 4 according to the fourth embodiment of the present invention, the configurations of the closures 2 and 3 according to the second and third embodiments of the present invention as described above. In other words, it is possible to form the concavo-convex portion 42 only in a portion of the lateral circumferential portion of the closure base portion 11. This allows reducing the amount of resin required for forming the concavo-convex portion 42.

### Fifth Embodiment

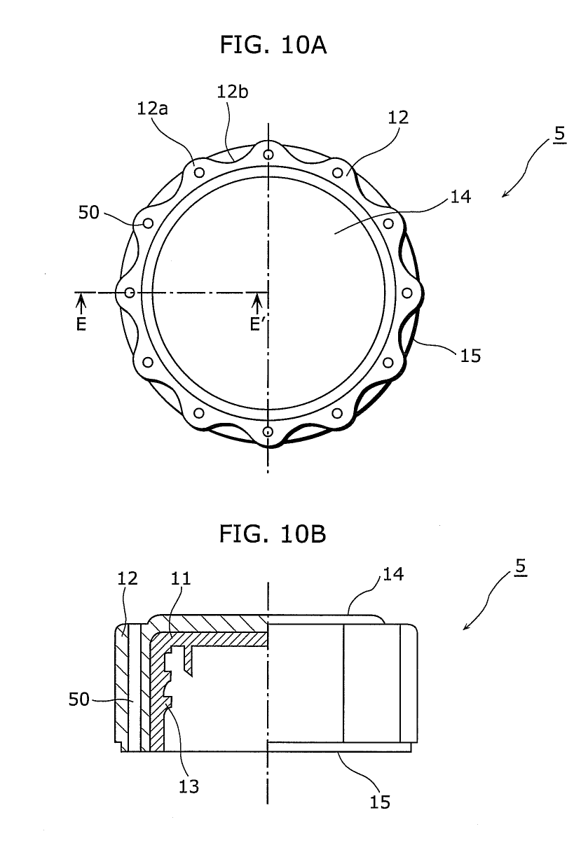

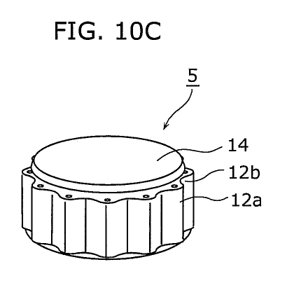

Next, the following will describe a closure 5 according to a fifth embodiment of the present invention. FIG. 10A is a plan view of the closure 5 according to the fifth embodiment of the present invention, and FIG. 10B is a partially cutaway cross-sectional side view of the closure 5 shown in FIG. 10A. A cross-sectional portion in FIG. 10B shows a cross section of the closure when cut away along line E-E′ shown in FIG. 10A. FIG. 10C is an external perspective view of the closure shown in FIGS. 10A and 10B.

As shown in FIGS. 10A to 10C, a feature of the closure 5 according to the fifth embodiment of the present invention is that a hollow portion 50 is formed in each of the convex portions of the concavo-convex portion 12 that is formed using the dodecagonal socket wrench hole. Note that the other configurations are the same as those of the closure 1 according to the first embodiment, and the descriptions thereof will therefore be omitted.

The hollow portion 50 is a region in which no resin is formed, and is an elongated through hole having a small diameter and formed along a height direction of the closure base portion 11. In addition, the hollow portion 50, as shown in FIG. 10A, is located on a straight line connecting an apex of one of the convex portions 12a and a center of the closure base portion 11, and is formed between adjacent concave portions 12b. The hollow portion 50 can be formed as a through hole of, for example, approximately 1.2 mm to 1.8 mm in diameter.

Thus, the closure 5 according to the fifth embodiment of the present invention has the hollow portion 50 in the concavo-convex portion 12, thus allowing reducing the amount of resin required for forming the concavo-convex portion 12.

Furthermore, the hollow portion 50 can be formed using a convex mold (core side mold) or a concave mold in which metallic core pins of approximately 1.2 mm to 1.8 mm are provided like needles projecting from a base. In this case, the cooling time and pressure keeping time required for injection molding of resin is proportional to the square of a thickness of the resin, but it is possible to significantly reduce the cooling time and pressure keeping time for the resin by thus inserting core pins and forming the concavo-convex portion 12. In addition, it is preferable that top portions of the core pins be tapered at around two degrees (draft angle) to reduce injection resistance of closure molding due to injection molding.

Note that the closure 5 according to the fifth embodiment of the present invention can produce the same advantageous effect as the advantageous effect produced by the closure 1 according to the first embodiment of the present invention. It is also possible to apply, to the closure 5 according to the fifth embodiment of the present invention, the configurations of the closures 2 to 4 according to the second to the fourth embodiments of the present invention as described above.

In addition, in the closure 5 according to the fifth embodiment of the present invention, the hollow portion 50 is formed as a through hole, but the present invention is not limited to this. For example, the hollow portion 50 may also be formed in a configuration such that either a top or a bottom of the through hole is closed, or in a configuration such that both the top and bottom of the through hole are closed.

In addition, a position, size, the number of the hollow portion 50 is not limited to such position, size, and the number as described above, and any configuration is possible as long as they produce an advantageous effect of the hollow portion as described above.

### Sixth Embodiment

Next, the following will describe an opener for opening the closures 1 to 5 according to the first to the fifth embodiments described above with reference to the drawings.

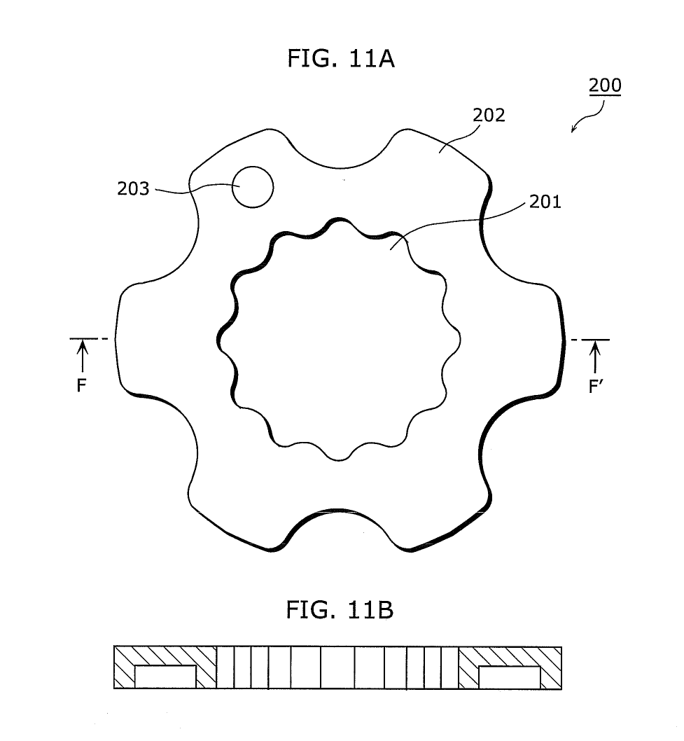

FIG. 11A is a plan view of an opener 200 according to a sixth embodiment of the present invention, and FIG. 11B is a partially cutaway cross-sectional side view of the opener 200 shown in FIG. 11A. Note that a cross-sectional portion in FIG. 11B shows a cross section of the opener when cut away along line F-F′ shown in FIG. 11A.

As shown in FIGS. 11A and 11B, the opener 200 according to the sixth embodiment of the present invention is approximately disk-shaped and includes, inside, a through hole 201 having the same convexo-concave portion as the convexo-concave portion of the dodecagonal socket wrench hole. In other words, the through hole 201 is formed to fit in the outer circumferential portion of the closures 1 to 5 according to the first to the fifth embodiments of the present invention, and an inner circumference of the through hole 201 includes a convexo-concave portion having the same form as the convexo-concave portion of the dodecagonal socket wrench.

In addition, an outer circumference of the opener 200, as shown in FIG. 11A, includes a concavo-convex portion 202 including six convex portions. The concavo-convex portion 202 is formed such that a diameter (outer diameter) of a circle connecting an apex of each of the six convex portions is approximately 45 mm to 65 mm. This is the same dimension as a water faucet handle. Note that as the material for the opener 200, for example, polypropylene (PP), polyethylene (PE), polystyrene (PS), polyvinyl chloride (PVC), or ABS resin can be used.

The opener 200 according to the sixth embodiment of the present invention is attached by engaging, in a spline state, the opener 200 into the closures 1 to 5 according to the first to the fifth embodiments of the present invention as described above.

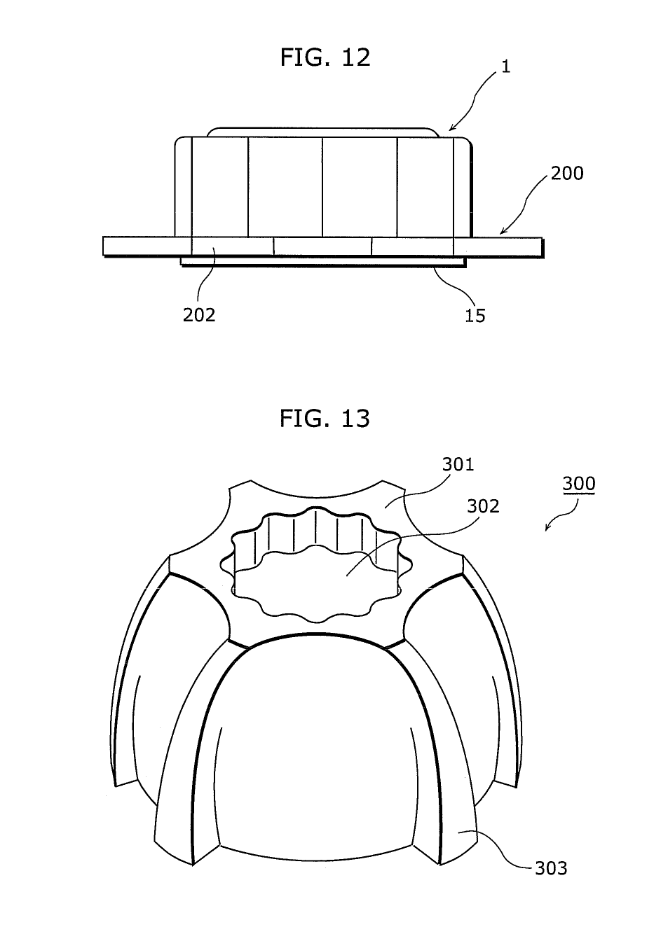

FIG. 12 is a diagram showing a state in which the opener 200 according to the sixth embodiment of the present invention is attached to the closure 1 according to the first embodiment of the present invention. Here, the state in which the opener 200 is attached to the closure 1 will be described.

The opener 200 according to the sixth embodiment of the present invention, when set onto the closure 1, may sometimes slip down due to its own weight to cause inconvenience. In this case, as shown in FIG. 1B, by providing the opener supporting portion 15 at an end of the cylindrical portion of the closure 1, the opener 200 can fit into a deeper position in the outer circumferential portion of the closure 1, thus allowing the opener 200 to keep its position in a stable state. In other words, the opener supporting portion 15 functions as a stopper of the opener 200.

Since the opener 200 according to the sixth embodiment of the present invention allows increasing a distance between a portion where force is applied by human fingers (a point of effort) and a portion where the force is applied to the closure (a point of load), thus allowing increase in turning torque. In addition, since the convexo-concave portion of the closure and the convexo-concave portion of the through hole 201 of the opener 200 are engaged together in a spline state, no slippage is caused between the concavo-convex portions of the closure and the through hole 201. Accordingly, use of the opener 200 allows weak grip users such as children, women, and the elderly to open the closure more easily.

Note that an outer dimension of the opener 200 should preferably be approximately 45 mm to 65 mm which is equivalent to an outer dimension of a water faucet handle which is approximately cross-shaped. This allows the opener 200 to have an outer diameter approximately double the diameter of the closure, thus allowing doubling the opening torque. Accordingly, in particular, those with a weak grip such as the elderly can open the closure easily. This is based on the fact that even those with a weak grip such as the elderly often manage to open or close the water valve with bare hands.

In addition, the opener 200, which is approximately disk-shaped and light in weight, is therefore convenient for portable use and can be manufactured at low costs.

In addition, as shown in FIG. 11A, a small hole 203 may be provided in an appropriate place in the concavo-convex portion 202 of the opener 200. Thus, by providing the small hole 203 and putting a string through the small hole 203, it is possible to hang the opener 200 from a plastic bottle or on a hook provided in the kitchen or the like.

In addition, to facilitate the attachment of the opener 200 to the closures 1 to 5, a taper of approximately 4 mm in vertical height may be provided in an upper part of the convex portion of the concavo-convex portion of the closures 1 to 5. This allows extremely smooth fitting of the opener 200 into the closures 1 to 5. Furthermore, it is possible to reduce the amount of resin required for forming the concavo-convex portion of the closures 1 to 5.

### Seventh Embodiment

Next, the following will describe, with reference to the drawings, another opener according to a seventh embodiment which is different from the opener 200 according to the sixth embodiment of present invention as described above.

FIG. 13 is an external perspective view of an opener 300 according to the seventh embodiment of the present invention.

As shown in FIG. 13, the opener 300 according to the seventh embodiment of the present invention is cap-shaped, and includes, in a top surface portion 301, a through hole 302 having the same convexo-concave portion as the convexo-concave portion of the dodecagonal socket wrench hole. In other words, the through hole 302 is formed to fit in the outer circumferential portion of the closures 1 to 5 according to the first to the fifth embodiments of the present invention, and the convexo-concave portion of an inner circumference of the through hole 302 has the same form as the convexo-concave portion of the dodecagonal socket wrench hole.

Here, the convexo-concave portion having the same form as the convexo-concave portion of the dodecagonal socket wrench hole only needs to have a form in which the convexo-concave portion of the through hole 302 fits in the concavo-convex portion of the closures 1 to 5 according to the first to the fifth embodiments of the present invention as described above. Since the form of fitting can be considered to be the same as the form of fitting described in the closure 1 according to the first embodiment of the present invention, the detailed description thereof will be omitted here.

In the opener 300 according to the seventh embodiment of the present invention, a socket wrench hole corresponding to the through hole 302 is the same as the socket wrench hole applied to the closures 1 to 5 according to the first to fifth embodiments of the present invention as described above. In other words, a socket of a dodecagonal socket wrench having a nominal size of 30 mm according to a JIS standard B4636-1 is applied. This allows the through hole 302 of the opener 300 according to the seventh embodiment of the present invention to fit in the concavo-convex portion of the closures 1 to 5 according to the first to the fifth embodiments of the present invention.

In addition, an outer circumferential form of the opener 300, as shown in FIG. 13, includes six convex portions 303. Each convex portion 303 is formed to have a protrusion which becomes larger from the top downward. Note that the opener 300 has a shape and dimension similar to those of a common water valve handle. Note that as the material for the opener 300, for example, polypropylene (PP), polyethylene (PE), polystyrene (PS), polyvinyl chloride (PVC), or ABS resin can be used.

In addition, since the opener 300 is compact and light in weight, the opener 300 is convenient for portable use and can be manufactured at low costs. Furthermore, since the opener 300 is cap-shaped, it is possible to fit the opener 300 onto the plastic bottle, put it in the bag, and casually carry when going out or travelling. In addition, the opener 300 is not likely to drop off or become missing when stored in a refrigerator.

(Variations)

As described thus far, the plastic bottle closure according to the embodiments of the present invention, the plastic bottle including the closure, and the opener for such a plastic bottle have been described in detail, but the plastic bottle closure and so on according to the present invention are not limited to these embodiments.

In addition, the configurations according to the first to the seventh embodiments are also applicable to each other. For example, the closures 2 to 5 according to the second to the fifth embodiments of the present invention may be included in a plastic bottle, as with the closure 1 according to the first embodiment, by screwing one of the closures 2 to 5 onto the opening 81 of the plastic bottle body 80 as shown in FIGS. 4 and 5.

Additionally, for example, the following variations are also included in the present invention.

(Variation 1)

In the embodiments above, a standardized dodecagonal socket wrench according to the JIS standards has been used, but the standard to be used is not limited to this. For example, International Organization Standardization (ISO) may also be used. For such ISO standards, for example, it is possible to use an ISO standard corresponding to JISB4636-1. Specifically, it is possible to use: ISO286-2, ISO/DIS691, ISO1174-1, ISO1711-1, ISO3315, and ISO3316.

In addition, it is possible to use another standard as long as a standardized dodecagonal socket wrench is used. For example, it is possible to use British Standard Whitworth, Inch Standard, US Standard Inch Size, or the like. Whatever standard may be used, it is possible to promote standardization of the closure by integrally applying the standard.

(Variation 2)

In the embodiments above, an existing closure included in a plastic bottle available on the market is used as the closure base portion 11, but the closure base portion 11 is not limited to this.

For example, a closure having the same shape as the existing closure may be prepared in advance and used.

Furthermore, it is not necessary to use the closure base portion 11 at all. If this is the case, the closure is formed as an integral component by performing, in the same manufacturing process, injection molding on a portion corresponding to the closure base portion 11 and the concavo-convex portion 12 at the same time. This allows configuring the closure as a molding product in which the closure base portion 11 and the concavo-convex portion 12 are integrally formed into one component.

(Variation 3)

In the closure 2 according to the second embodiment above, the concavo-convex portion 22 has been formed only in an upper part of a lateral portion of the closure, and in the closure 3 according to the third embodiment above, the concavo-convex portion 32 has been formed only in a lower part of the lateral portion of the closure, but the present invention is not limited to this.

In other words, the concavo-convex portion may be formed only in a portion in the height direction of the closure, and may be formed, for example, only around a center of the lateral portion of the closure.

Note that the configuration in which the closure base portion is exposed at least in a lower part of the concavo-convex portion allows the fingers to reach and catch the back side of the concavo-convex portion, thus allowing opening or closing the closure easily.

(Variation 4)

In the embodiments above, the closures 1 to 5 according to the first to the fifth embodiments of the present invention and the openers 200 and 300 according to the six and the seventh embodiment of the present invention have been described as separate configurations, but it is also possible to use one of the closures and one of the openers as an integral configuration.

Specifically, it is possible to realize a closure with an opener or a plastic bottle with an opener which is in a state which one of the openers 200 and 300 according to the six and seventh embodiments of the present invention is attached to one of the closures according to the first to the fifth embodiments of the present invention or the plastic bottles including the closure.

With this, it is possible to sell the closure with an opener or the plastic bottle with an opener. However, it is not necessary to attach the opener to every bottle for selling; instead, the closure and the opener may be separately sold as separate items as described in the embodiments described above, or a sale of such a plastic bottle with an opener may be gradually reduced as the openers become more popular. Note that the closures and openers described above can be diverted to another plastic bottle, thus producing an advertising effect to attract those using plastic bottles manufactured by other companies. Note that printing to the closure top surface is possible as usual. Such forms of openers are comparable to an opener conventionally distributed by beer or other beverage manufacturers for sales promotion.

(Variation 5)

In the closures 1 to 5 according to the first to the fifth embodiments of the present invention, it is preferable that a gear-shaped concavo-convex portion or an entire closure be in metallic color such as gold, silver, or bronze.

A closure in metallic color and a plastic bottle including such a closure are associated with a metallic gear, and can impress those buying or using the plastic bottle with their mechanical functional beauty. Thus, the closure in metallic color and the plastic bottle including such a closure further represent their mechanical functional beauty, and can thereby stand out on display shelves.

Particularly, since the concavo-convex portion 42 of the closure 4 according to the fourth embodiment of the present invention as shown in FIGS. 9A to 9B is spur-gear shaped, forming the closure 4 according to the fourth embodiment of the present invention in metallic color produces a significant advantageous effect as described above.

(Variation 6)

In the first to the fifth embodiments of the present invention, the plastic bottle body may contain sparking drink such as carbonated drink, sparkling liquor, or beer.

Conventionally, some people, anticipating difficulty in re-opening the plastic bottle, do not tightly fasten the closure of the plastic bottle containing leftover drink. This causes a problem that the content of the plastic bottle becomes flat (loses gas) when sparkling drink is in the plastic bottle. However, with the closure according to an implementation of the present invention, it is possible to easily open the closure, thus making it possible to fasten the closure tightly even when the plastic bottle contains leftover sparkling drink. Accordingly, this solves the problem of the drink in the plastic bottle becoming flat.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

A closure and a plastic bottle according to the present invention is applicable to various types of plastic bottles which allow those with a weak grip to easily open or close the closure. In addition, an opener according to the present invention is appropriate for opening or closing the closure described above.

What is claimed is:

1. A plastic bottle closure that is screwed onto an opening of a plastic bottle body,
wherein an outer circumferential form of said plastic bottle closure includes a concavo-convex portion in which each of twelve concave portions and each of twelve convex portions are alternately arranged, and
said concavo-convex portion of said plastic bottle closure fits in a convexo-concave portion of an inner circumferential form of a hole of a dodecagonal socket wrench that is standardized.

2. The plastic bottle closure according to claim 1,
wherein, when a circle connecting an apex of each of said twelve convex portions in said plastic bottle closure is a closure addendum circle, and a circle connecting a bottom of each of said twelve concave portions is a closure dedendum circle, and
when a circle connecting an apex of each of twelve concave portions of the dodecagonal socket wrench is a wrench hole addendum circle, and a circle connecting a bottom of each of twelve concave portions of the dodecagonal socket wrench is a wrench hole dedendum circle,
said plastic bottle closure is represented by: diameter of the closure dedendum circle diameter of the wrench hole addendum circle<diameter of the closure addendum circle diameter of the wrench hole dedendum circle.

3. The plastic bottle closure according to claim 1,
wherein said plastic bottle closure is approximately circular-arc shaped at a bottom of each of said twelve concave portions in said concavo-convex portion.

4. The plastic bottle closure according to claim 1,
wherein said concavo-convex portion is formed only in a portion in a height direction of said plastic bottle closure.

5. The plastic bottle closure according to claim 4,
wherein said concavo-convex portion is formed only in an upper part of a lateral portion of said plastic bottle closure and is also formed in an entire circumference of the lateral portion of said plastic bottle closure.

6. The plastic bottle closure according to claim 4,
wherein said concavo-convex portion is formed only in a lower part of a lateral portion of said plastic bottle closure and is also formed in an entire circumference of the lateral portion of said plastic bottle closure.

7. The plastic bottle closure according to claim 1,
wherein a flat portion is formed in each of said twelve convex portions in said concavo-convex portion, said flat portion having an angular shape at each of end portions.

8. The plastic bottle closure according to claim 1,
wherein a through hole having a diameter of 1.2 mm to 1.8 mm is formed in each of said twelve convex portions in said concavo-convex portion.

9. The plastic bottle closure according to claim 1,
wherein the dodecagonal socket wrench is specified by Japanese Industrial Standards (JIS), according to a JIS standard number B4636-1.

10. The plastic bottle closure according to claim 9,
wherein the dodecagonal socket wrench has a nominal size of 30 mm.

11. A plastic bottle comprising:
the plastic bottle closure according to claim 1; and
a plastic bottle body including an opening onto which the plastic bottle closure is screwed.

12. An opener for opening the plastic bottle closure according to claim 1, said opener comprising
a through hole having a same shape as a hole of a standardized dodecagonal socket wrench.
